(19) United States
(12) Patent Application Publication
(10) Pub. No.: US 2012/0324177 A1
(43) Pub. Date: Dec. 20, 2012

(54) APPARATUS AND METHOD FOR ACCESSING NETWORK MEMORY

(76) Inventors: Hyun-Sung Shin, Seoul (KR); In-Su Choi, Hwaseong-si (KR)

(21) Appl. No.: 13/434,335

(22) Filed: Mar. 29, 2012

(30) Foreign Application Priority Data
Jun. 16, 2011 (KR) 10-2011-0058737

(51) Int. Cl. G06F 12/00

(52) U.S. Cl. 711/154; 711/E12.001

(57) ABSTRACT

In one embodiment, the apparatus includes a media access control (MAC) processor and a memory controller. The MAC processor is connected to a physical layer of the network, parses a frame received from the physical layer, and outputs a memory command. The memory controller outputs first data received from the network to the network memory or second data output from the network memory to the network according to the memory command.

### CROSS-REFERENCE TO RELATED APPLICATION

This application claims priority under 35 U.S.C. §119 to Korean Patent Application No. 10-2011-0058737 filed on Jun. 16, 2011, in the Korean Intellectual Property Office (KIPO), the entire contents of which are incorporated herein by reference.

### BACKGROUND

1. Field

At least one example embodiment relates to an apparatus and/or method for accessing a network memory and, more particularly, to an apparatus and/or method for giving a plurality of processors access to a network memory within a network in which the processors and the network memory are interconnected.

2. Description of Related Art

In typical computing systems, memories are dependent on respective central processing units (CPUs). As such, when one CPU refers to the memory of another CPU, the CPU does not gain direct access to the memory of the other CPU, and thus accesses the memory of the other CPU over, for instance, Ethernet.

In this case, the operation of a program is restricted to a capacity of the memory allocated to each CPU.

### SUMMARY

At least one example embodiment provide an apparatus that is located in front of a network memory within a network in which a plurality of processors and the network memory are interconnected and that directly gives the processors access to the network memory.

At least one example embodiment may also provide a method of directly giving a plurality of processors access to a network memory within a network in which the processors and the network memory are interconnected.

Example embodiments are not limited to the above disclosure; other objectives may become apparent to those of ordinary skill in the art based on the following descriptions.

In accordance with an aspect of at least one example embodiment, an apparatus for giving a plurality of processors access to a network memory within a network in which the processors and the network memory are interconnected includes a media access control (MAC) processor and a memory controller. The MAC processor is connected to a physical layer of the network, parses a frame received from the physical layer, and outputs a memory command. The memory controller outputs first data received from the network to the network memory or second data output from the network memory to the network according to the memory command.

In an embodiment, the frame may have a media independent interface (MII) data structure.

In another embodiment, the frame may further include the memory command and a memory address for executing the memory command.

In still another embodiment, the memory controller may output a control signal, and the apparatus may further include a data converter configured to convert a structure of the first data into a structure of the second data corresponding to the control signal, or vice versa.

In yet another embodiment, the apparatus may further include a burst length counter configured to count the data by a burst length of the network memory according to the control signal, and then output a count signal. The data converter may convert the structure of the first or second data according to the count signal.

In yet another embodiment, the apparatus may further include a plurality of buffers configured to temporarily store and output the data converted into the structure of the second data output from the data converter or the second data output from the network memory.

In yet another embodiment, the apparatus may further include a latch disposed between the data converter and the plurality of buffers, and configured to latch the data converted into the structure of the second data by the data converter or the data output from the plurality of buffers to the data converter.

In yet another embodiment, the apparatus may further include a memory clock buffer configured to temporarily store a first clock received from the MAC processor or a second clock created by the memory clock buffer, and output the stored clock to the network memory.

In yet another embodiment, when the MAC processor detects an error generated from the physical layer and outputs an error signal, the memory controller may output a refresh or power-down command to the network memory.

In accordance with another aspect of example embodiments, a method of giving a plurality of processors access to a network memory within a network in which the processors and the network memory are interconnected includes parsing a frame received from a physical layer of the network to determine a memory command. Then, according to the memory command, first data received from the network are output to the network memory, or second data output from the network memory are output to the network.

In an embodiment, outputting the first or second data may include converting a structure of the first data into a structure of the second data with reference to a burst length of the network memory or vice versa, and outputting the converted result.

In another embodiment, the method may further include outputting a refresh or power-down command to the network memory when an error generated from the physical layer is detected.

In still another embodiment, the frame may have a media independent interface (MII) data structure.

In yet another embodiment, the frame may further include the memory command and a memory address for executing the memory command.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a network configuration diagram according to at least one example embodiment;

FIG. 2 is a detailed block diagram showing the network memory module of FIG. 1;

FIG. 3 is a block diagram showing the memory access unit in accordance with at least one example embodiment;

FIG. 4 shows a structure of a MAC frame according to at least one example embodiment; and

FIG. 5 shows components performing data conversion.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

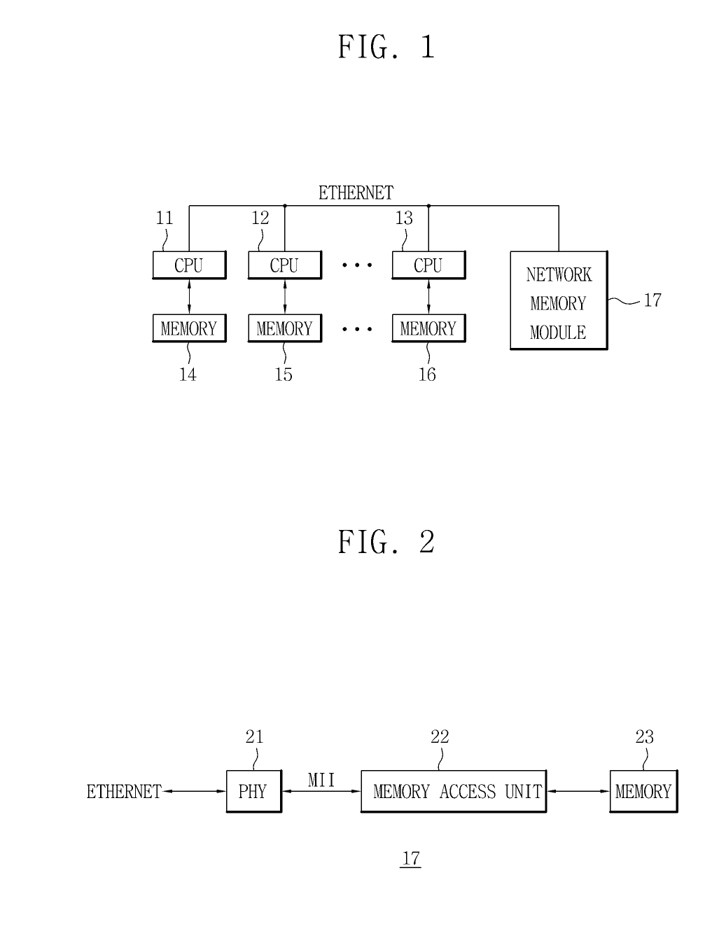

FIG. 1 is a network configuration diagram according to at least one example embodiment.

In the shown network, a plurality of central processing units (CPUs) is connected to a network memory module. The CPUs 11, 12 and 13 are connected to respective local memories 14, 15 and 16. The CPUs 11, 12 and 13 are also connected to the network memory module 17 over an Ethernet.

FIG. 2 is a detailed block diagram showing the network memory module 17 of FIG. 1.

The shown network memory module 17 includes a physical layer (PHY) 21 directly connected to the Ethernet, a memory access unit 22 connected to the PHY 21 via a media independent interface (MII), and a memory 23 directly connected to the memory access unit 22.

The MII interface may, for example, comply with the known, corresponding IEEE standards, and may connect various physical layers such as a gigabit Ethernet, a wireless Ethernet, and so on to each other.

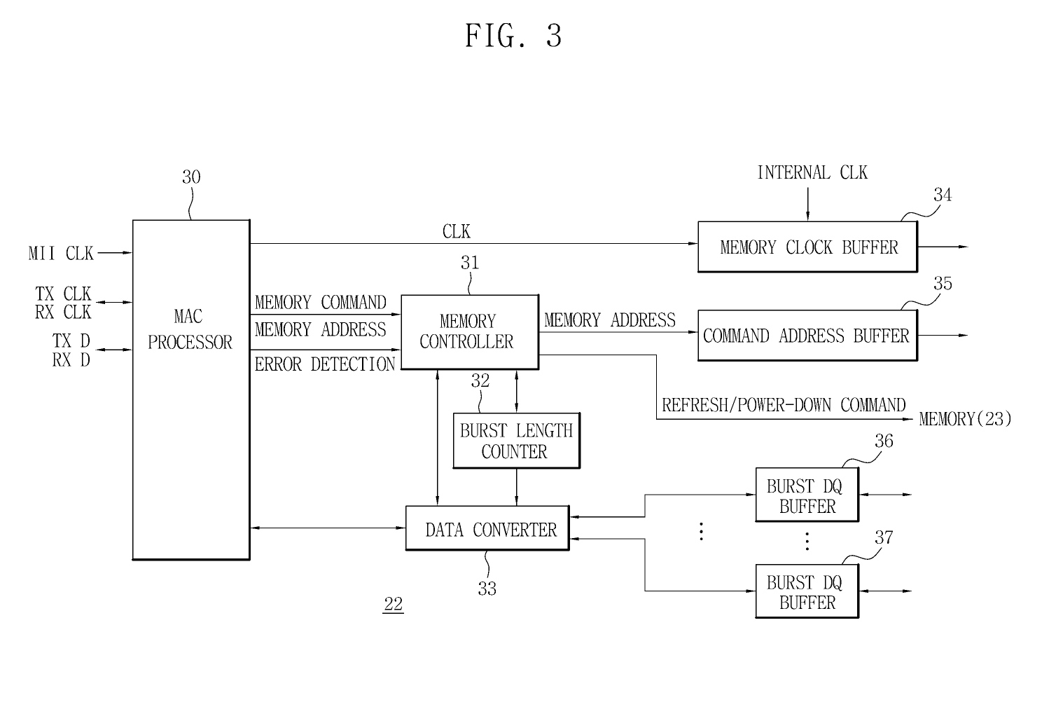

FIG. 3 is a block diagram showing the memory access unit 22 according to at least one example embodiment.

The memory access unit 22 shown in FIG. 3 includes a media access control (MAC) processor 30 and a memory controller 31. The memory access unit 22 may further include a burst length counter 32, a data converter 33, a memory clock buffer 34, a command address buffer 35, and a plurality of burst data (DQ) buffers 36 and 37.

The MAC processor 30 uses a 10G MII (XGMII) mode of 10G Ethernet as a basic configuration. Thus, carrier sense multiple access/collision detect (CSMA/CD), bankoff, collision sense, carrier sense, carrier extension, burst transmission, and auto-negotiation, none of which are used in the XGMII, are not used in the embodiment.

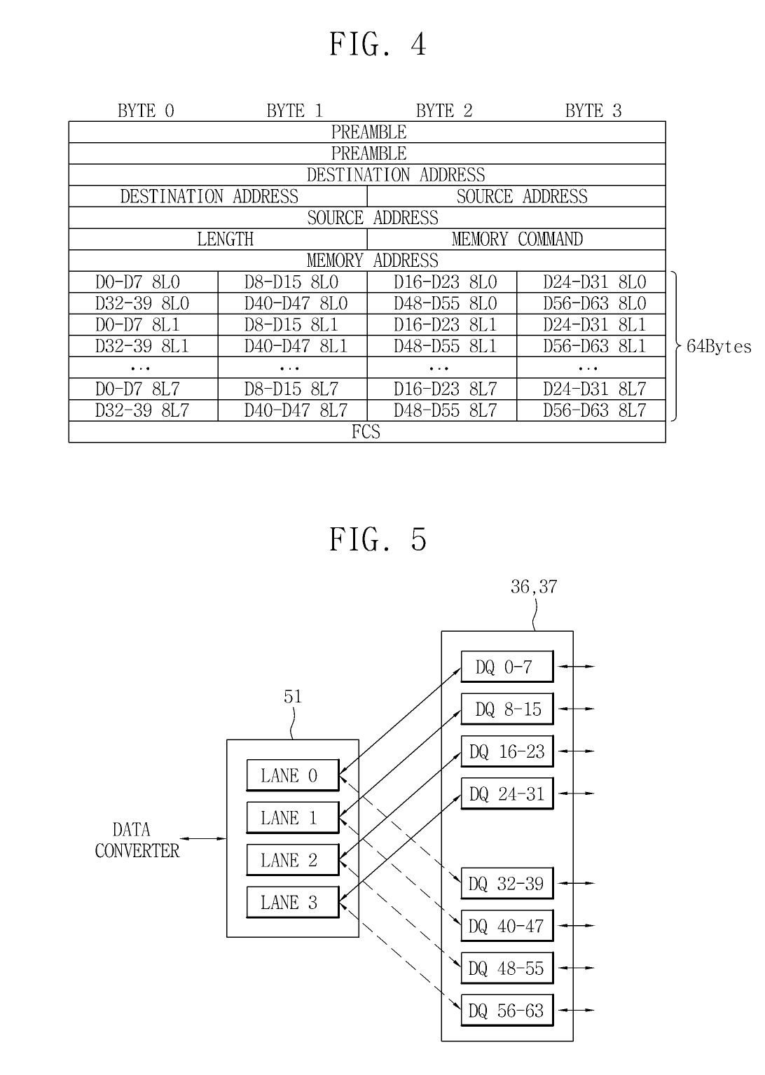

A MAC frame input through the MII has a structure as shown in FIG. 4. The shown MAC frame has a fixed length of 128 bytes in total, which are allocated for a preamble of 8 bytes, destination address of 6 bytes, a source address of 6 bytes, a length of 2 bytes, data of 64 bytes, and a frame check sequence (FCS) of 5 bytes. In the embodiment, the MAC frame further includes a memory command of 2 bytes for reading or writing of the network memory, and a memory address of 2 bytes.

The MAC processor 30 parses the MAC frame input through the MII, and terminates when the destination address of the MAC frame is not its own MAC address. The MAC processor 30 outputs the memory command to the memory controller 31 and the memory address for reading or writing to the command address buffer 35 when the destination address of the MAC frame is its own MAC address and when the MAC frame has the memory command. The MAC processor 30 outputs the data to the data converter 33 when the memory command is a “write” command. When the memory command is a “read” command, the MAC processor 30 makes the data, which is output from the data converter 33, into the frame structure shown in FIG. 4, and outputs it to a network.

Further, when an error takes place at an Ethernet PHY, the MAC processor 30 outputs an error signal to the memory controller 31, and outputs an MII clock (CLK) or a receive (RX) CLK received from the PHY 21 to the memory clock buffer 34. The memory clock buffer 34 outputs a clock output from the MAC processor 30 or a clock created from a self-oscillator so as to be used as a memory clock to the memory 23.

The MAC processor 30 may further include a, FCS logic processor (not shown) and a buffer (not shown). The FCS logic processor may have the structure and operation of any known FCS logic processor.

The memory controller 31 outputs an ON signal to the burst length counter 32 in order to process data in units of bursts when receiving the memory command from the MAC processor 30, and then counts the data by a burst length.

The memory controller 31 also transmits the memory address output from the MAC processor 30 to the memory 23 via the command address buffer 35, and outputs a refresh or power-down command to the memory 23 according to the error signal output from the MAC processor 30 until the error signal is terminated.

When the memory 23 is a dynamic random access memory (DRAM), a separate controller such as a refresh counter for controlling the memory may be provided to perform a refresh operation.

When the memory command is a “write” command, the data converter 33 truncates the data output from the MAC processor 30 according to the signal output from the burst length counter 32 in units of burst length, and outputs the truncated data to the burst DQ buffers 36 and 37. The burst DQ buffers 36 and 37 are directly connected to DQ lines of the memory 23.

When the memory command is a “read” command, the data converter 33 converts data of the burst length output to the burst DQ buffers 36 and 37 into serial data, and outputs the serial data to the MAC processor 30.

FIG. 5 shows components performing data conversion. As shown, a latch 51 may be disposed between the data converter 33 and the burst DQ buffers 36 and 37. The latch 51 may be embodied as a flip-flop.

When the MAC processor 30 employs the XGMII, the data is transmitted and received at a double data rate (DDR) in units of 32 bits. When the MAC processor 30 employs another MII, units other than 32 bits, such as 8 bits, may be used. In light of the XGMII, the data output from the data converter 33 is latched by the latch 51 made up of lanes 0 to 3 having the 8-bit units, and is connected to the burst DQ buffers 36 and 37. The data is connected first to the burst DQ buffer corresponding to the first 32-bit DQ (solid line) and second to the burst DQ buffer corresponding to the next 32-bit DQ (dashed line). In this way, the data is repetitively and alternately connected to the burst DQ buffers.

When the memory command is a “read” command, the data corresponding to the first 32 bits among the data output from the burst DQ buffers 36 and 37 is latched by the latch 51, and then output to the data converter 33, and the data corresponding to the next 32 bits is latched and output to the data converter 33.

According to at least one example embodiment, the apparatus for accessing the network memory enables each CPU to directly share the network memory over a network without passing through the other CPUs.

When cloud service is provided in a server environment, a substantial cloud shared memory rather than a virtual memory using software can be realized.

Each CPU can flexibly overcome a limit to a memory capacity using the network memory when its local memory is short of a capacity.

When the MII is applied to the network memory, signal integrity can be further improved than a conventional memory that gets much load.

Since the network memory is directly connected to a network via the MIT, a variety of applications such as a wireless memory storage, an optical memory card, etc. can be made.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. An apparatus for giving a plurality of processors access to a network memory within a network in which the processors and the network memory are interconnected, the apparatus comprising:
a media access control (MAC) processor connected to a physical layer of the network, configured to parse a frame received from the physical layer, and configured to output a memory command; and
a memory controller configured to output first data received from the network to the network memory or second data output from the network memory to the network via the MAC processor according to the memory command.

2. The apparatus according to claim 1, wherein the frame has a media independent interface (MII) data structure.

3. The apparatus according to claim 2, wherein the frame further includes the memory command and a memory address for executing the memory command.

4. The apparatus according to claim 1, wherein the memory controller is configured to output a control signal, and the apparatus further includes a data converter configured to convert a structure of the first data into a structure of the second data or convert a structure of the second data into a structure of the first data based on to the control signal.

5. The apparatus according to claim 4, further comprising:
a plurality of buffers configured to store and output the data converted into the structure of the second data output from the data converter or the second data output from the network memory.

6. The apparatus according to claim 4, further comprising:
a burst length counter configured to count the data by a burst length of the network memory according to the control signal, and then output a count signal, wherein the data converter is configured to convert the structure of the first or second data according to the count signal.

7. The apparatus according to claim 6, further comprising:
a plurality of buffers configured to store and output the data converted into the structure of the second data output from the data converter or the second data output from the network memory.

8. The apparatus according to claim 7, further comprising:
a latch between the data converter and the plurality of buffers the latch being configured to latch the data converted into the structure of the second data by the data converter or the data output from the plurality of buffers to the data converter.

9. The apparatus according to claim 1, further comprising:
a memory clock buffer configured to store a first clock received from the MAC processor or a second clock created from the memory clock buffer, and output the stored clock to the network memory.

10. The apparatus according to claim 1, wherein, the MAC processor is configured to detect whether an error has been generated from the physical layer and to output an error signal based on the detection, and the memory controller is configured to output a refresh or power-down command to the network memory based on the error signal.

11.-15. (canceled)

16. An apparatus for providing one or more processors with access to a network memory device via a network including the one or more processors and the network memory device, the apparatus comprising:
a memory controller configured to control an operation of the network memory; and
a media access control (MAC) processor connected to the memory controller, the MAC processor being configured to receive one or more MAC frames from the one or more processors via a physical layer of the network, configured to extract a memory command and a memory address from each of the one or more received MAC frames, and configured to forward each extracted memory command and memory address to the memory controller.

17. The apparatus of claim 1, wherein the memory command is a read command or a write command for each of the one or more received MAC frames, and the MAC processor is configured such that for each of the one or more received MAC frames the MAC processor forms an outgoing MAC frame including data read from the network memory and forwards the outgoing MAC frame to the network if the memory command is a read command, and the MAC processor extracts write data from the received MAC frame and sends the extracted write data to the network memory if the memory command is a write command.
